(19) United States
(12) Patent Application Publication
(10) Pub. No.: US 2009/0241281 A1
(43) Pub. Date: Oct. 1, 2009

(54) ASSEMBLY FOR REMOVING DEBRIS FROM A WINDSHIELD

(76) Inventor: John H. Couch, Rochester Hills, MI (US)

Correspondence Address: HARNESS, DICKEY & PIERCE, P.L.C., P.O. BOX 828, BLOOMFIELD HILLS, MI, 48303, US

(21) Appl. No.: 12/296,194

(22) PCT Filed: Apr. 5, 2007
(86) PCT No.: PCT/US07/08602

§ 371 Date: Oct. 6, 2008

Related U.S. Application Data
(60) Provisional application No. 60/790,001, filed on Apr. 6, 2006.

(51) Int. Cl. B60S 1/04

(52) U.S. Cl. 15/250.19

(57) ABSTRACT

A wiper system for use with a windshield includes a wiper arm and a separator assembly. The wiper arm includes a wiper blade movable between a use position and a raised position. The wiper blade is in contact with the windshield in the use position and removed from the windshield in the raised position. The separator assembly includes a base and an air bladder secured to the base. The base is adapted to receive a source of pressurized air for selectively inflating the air bladder to toggle the wiper blade between the use position and the raised position.

### CROSS-REFERENCE TO RELATED APPLICATIONS

This application claims the benefit of U.S. Provisional Application No. 60/790,001, filed on 6 Apr. 2006. The disclosure of the above application is incorporated herein by reference.

### FIELD

The present invention relates to wiper assemblies and more particularly to a wiper assembly capable of removing debris trapped under a wiper with an inflatable air bladder.

### INTRODUCTION

In using a windshield in either an automotive application or in other applications such as in boating, heavy machinery or the like, it is imperative that the operator be able to clearly see through the windshield to steer and maneuver the machine. Further, it is desirable that the operator be able to clearly see through the windshield in inclement weather conditions such as in rain, sleet, or snow. Further yet, it is desirable that the operator be able to remotely clean the windshield of foreign substances such as dirt, leaves, and other mire to maintain visibility. To that end, a windshield wiper system cooperating with an outer surface of a windshield plays a significant role.

Maintaining a clean windshield is crucial in the safe and responsible operation of a vehicle to ensure that the operator is able to clearly see and steer the vehicle through various weather and driving conditions. In this regard, a windshield wiper system is conventionally used to articulate back and forth across the windshield of a vehicle in an effort to wipe away moisture or debris, thereby providing the operator and other occupants with a clear sight path through the windshield.

Conventional wiper systems typically include a pair of arms rotatably driven by a wiper motor, whereby each arm includes a wiper blade in uniform contact with an outer surface of the windshield extending over a predetermined surface of the windshield. The wiper blade is conventionally fabricated from an elastomeric material, thereby allowing the blade to conform to the generally complex and curved shape of the windshield. The effectiveness of the wiper system is directly related to the ability of the wiper blade to maintain a uniform contact with the windshield throughout the region of the predetermined surface such that water can be effectively trapped between the blade and the windshield and ultimately removed through articulation of the arms.

The wiper motor serves to articulate the arms across the predetermined surface in an effort to clean the windshield and improve visibility. The sweeping motion of the wiper arms catches debris collected on an outer surface of the windshield and serves to move the debris to an outer edge thereof. In doing so, the wiper arms effectively move debris out of the line of vision of the operator and other occupants, thereby improving visibility. In this manner, larger objects such as leaves or pine cones are caught by the arm and are moved to the side of the windshield through the back and forth movement of each arm. For water and other smaller objects such as pine needles or bugs, the wiper blade contacts the object and serves to move or push the debris to the sides of the windshield. In either situation, the debris is often removed by the forward movement of the vehicle in cooperation with the movement of the arms such that the wind rushing over the windshield removes the debris all together.

The operation of the wiper system is hindered when debris is collected under the wiper blade, thereby preventing a uniform engagement between the wiper blade and the windshield. In this manner, the wiper system cannot function properly when debris is trapped between the wiper blade and the windshield as water cannot effectively be trapped between the wiper blade and the windshield when the blade is locally removed from contact with the windshield by debris. By hindering the operation of the wiper assembly, debris trapped between the wiper blade and the windshield makes operation of the vehicle difficult as visibility through the windshield is reduced.

In addition to debris, collection of frozen water between the blade and the windshield in the form of ice or slush similarly causes the blade to locally disengage the windshield, thereby hindering operation of the wiper system. In addition to locally lifting the wiper blade from contact with the windshield, the temperature of the ice or slush often hardens the wiper blade, thereby not allowing the blade to conform to the shape of the windshield. Further, the hardening of the ice or slush may even freeze the blade in one position such that the motor cannot rotate the arms. In any event, the operator is often required to remove the debris from under the blade by lifting the blade from contact with the windshield and manually removing the debris. In the case of frozen water or slush, the operator is often required to quickly lift the blade from contact with the windshield and allow the blade to snap back, thereby dislodging any ice or snow from the blade.

Conventional wiper systems have been modified to incorporate debris removing systems, operating on the principal that by lifting the wiper arm and removing the wiper blade from contact with the windshield, the debris collected between the wiper blade and the windshield will be released, thereby allowing the debris to be removed by a rush of air caused by the forward movement of the vehicle. Such systems, while adequately lifting the wiper blade from contact with the windshield, typically require interaction with an apparatus mounted on an external surface of the vehicle such as a ramp or a lift. In this manner, the lift or the ramp is visible on the exterior of the vehicle whether the wiper system is in use or not, thereby reducing the overall aesthetics of the vehicle and increasing drag over the windshield.

Commonly assigned U.S. Pat. No. 6,859,972 and U.S. Publication No. 2005-0155174-A1 are generally directed to wiper assemblies for removing debris trapped under a wiper. U.S. Pat. No. 6,859,972 and U.S. Publication No. 2005-0155174-A1 are incorporated by reference as if fully set forth herein.

A continuous need for improvement of the pertinent art remains.

### SUMMARY

Accordingly, the present teachings provide a wiper system for use with a windshield including a wiper arm having a first and second end. The first end of the wiper arm includes a reaction surface disposed thereon while the second end includes a wiper blade biased into engagement with the windshield. In addition, a drive motor is fixedly attached to the first end of the wiper arm, whereby the drive motor includes a drive shaft operable to pivot the wiper arm across the windshield. A separator assembly is further provided and is supported by the drive shaft. The separator assembly is disposed within the arm and is operable to react against the reaction surface of the arm to selectively lift the wiper arm from engagement with the windshield. The separator assembly includes an air bladder.

According to one particular aspect, the present teachings provide a wiper system for use with a windshield. The wiper system includes a wiper arm and a separator assembly. The wiper arm includes a wiper blade movable between a use position and a raised position. The wiper blade is in contact with the windshield in the use position and removed from the windshield in the raised position. The separator assembly includes a base and an air bladder secured to the base. The base is adapted to receive a source of pressurized air for selectively inflating the air bladder to toggle the wiper blade between the use position and the raised position.

According to another particular aspect, the present teachings provide a wiper system for use with a windshield. The wiper system includes a base member to be driven about an axis. A wiper arm carries a wiper blade and is coupled to the base for movement between a normal use position in which the wiper blade is against the windshield and a raised position in which the wiper blade is displaced from the windshield. An air bladder is connected to the base in a fluid tight manner. A source of pressurized fluid is in communication with the base for inflating the bladder to move the wiper arm from the normal use position to the raised position.

Further areas of applicability of the present teachings will become apparent from the detailed description provided hereinafter. It should be understood that the detailed description and specific examples, while indicating the certain embodiments, are intended for purposes of illustration only and are not intended to limit the scope of the present teachings.

### DRAWINGS

The present teachings will become more fully understood from the detailed description and the accompanying drawings, wherein:

FIG. 1 is a perspective view of a wiper assembly for a motor vehicle in accordance with the present teachings.

FIG. 2 a side view of a portion of the wiper assembly in accordance with the present teachings, the wiper blade of the wiper assembly shown oriented to a normal use position.

FIG. 3 is a view similar to FIG. 2, illustrating the wiper blade in accordance with the present teachings articulated to a position displaced from a windshield.

FIG. 3A is another view similar to FIG. 2, illustrating another wiper assembly for a motor vehicle in accordance with the present teachings.

FIG. 4 is a partially exploded side view of the wiper assembly in accordance with the present teachings.

FIG. 5 is a perspective view of a base member of the wiper assembly in accordance with the present teachings.

FIG. 6 is another perspective view of a base member of the wiper assembly in accordance with the present teachings.

FIG. 7 is a cross-sectional view taken along the line 7-7 of FIG. 5.

### DESCRIPTION OF VARIOUS ASPECTS

The following description is merely exemplary in nature and is not intended to limit the present disclosure, application, or uses. It should be understood that throughout the drawings, corresponding reference numerals indicate like or corresponding parts and features.

With reference to the drawings, a wiper system in accordance with the present teachings is illustrated and generally identified at reference character 10. The wiper assembly 10 is illustrated to generally include a separator assembly 12, a wiper arm 14, a linkage 16 and a wiper blade 18. To the extent not otherwise described herein, it will be understood that the wiper arm 14, the linkage 16 and the wiper blade 18 are conventional in construction insofar as the present teachings are concerned.

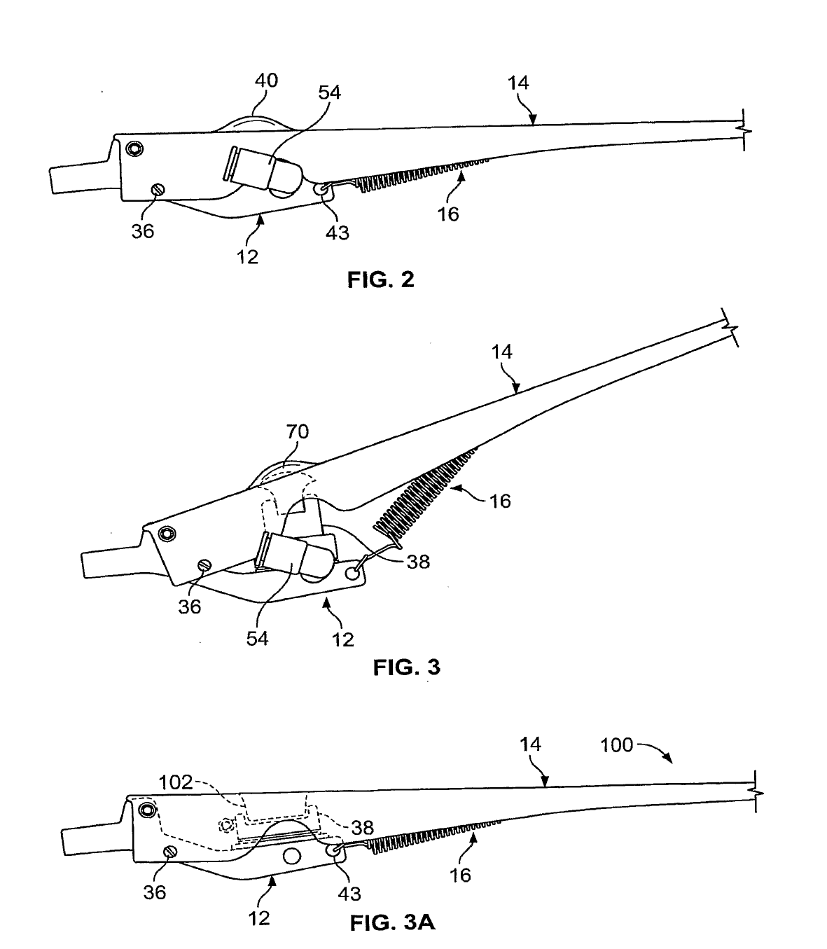

FIG. 2 illustrates the wiper arm 14 and wiper blade 18 oriented in a normal use position or lowered position. In this normal use position, the wiper blade 18 may be positioned adjacent a windshield (not shown) for normal cleaning of the windshield. FIG. 3 illustrates the wiper arm 14 and wiper blade 18 articulated to a raised position. In the raised position, the wiper blade 18 may be upwardly displaced from windshield against a conventional biasing force imparted by the linkage 16. As will be appreciated more fully below, the wiper arm 14 and wiper blade 18 may be quickly and repeatedly raised and lowered such that the wiper blade 18 is slapped against the windshield to facilitate the removal of debris. Such debris may include, but is not limited to, ice, leaves, paper, and the like.

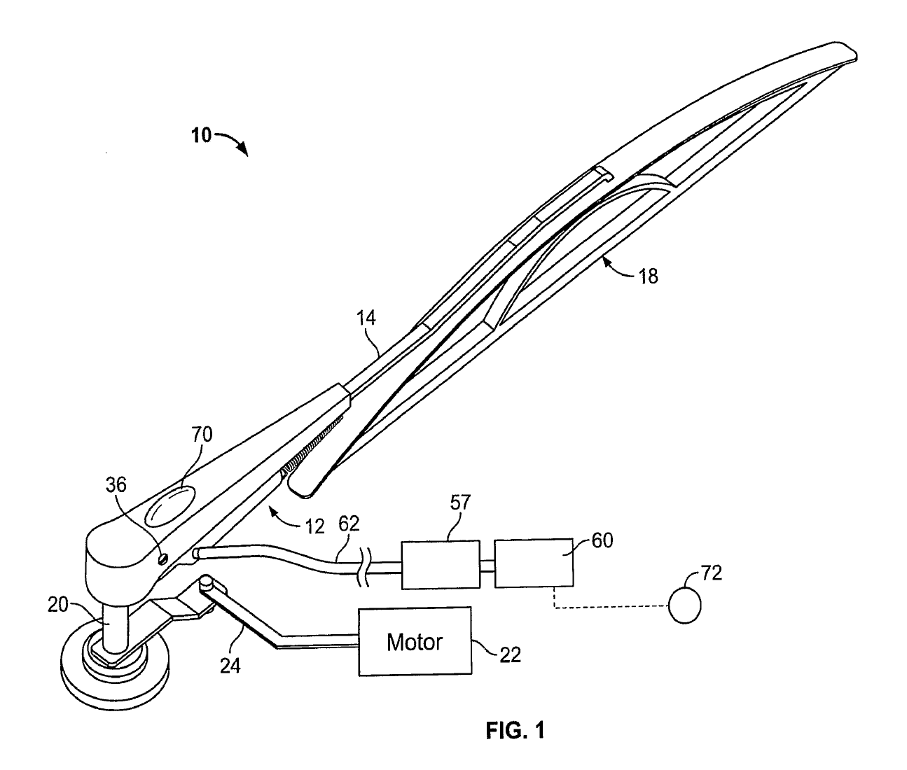

As shown in the perspective view of FIG. 1, the wiper assembly 10 may be driven by an output shaft 20 of a conventional motor vehicle wiper system. The output shaft 20 may be connected to a motor 22 through a linkage 24. The particular arrangement shown in FIG. 1 should be understood to be exemplary in nature. In this regard, the wiper assembly 10 in accordance with the present teachings may be readily adapted to be used with various conventional wiper system drive arrangements.

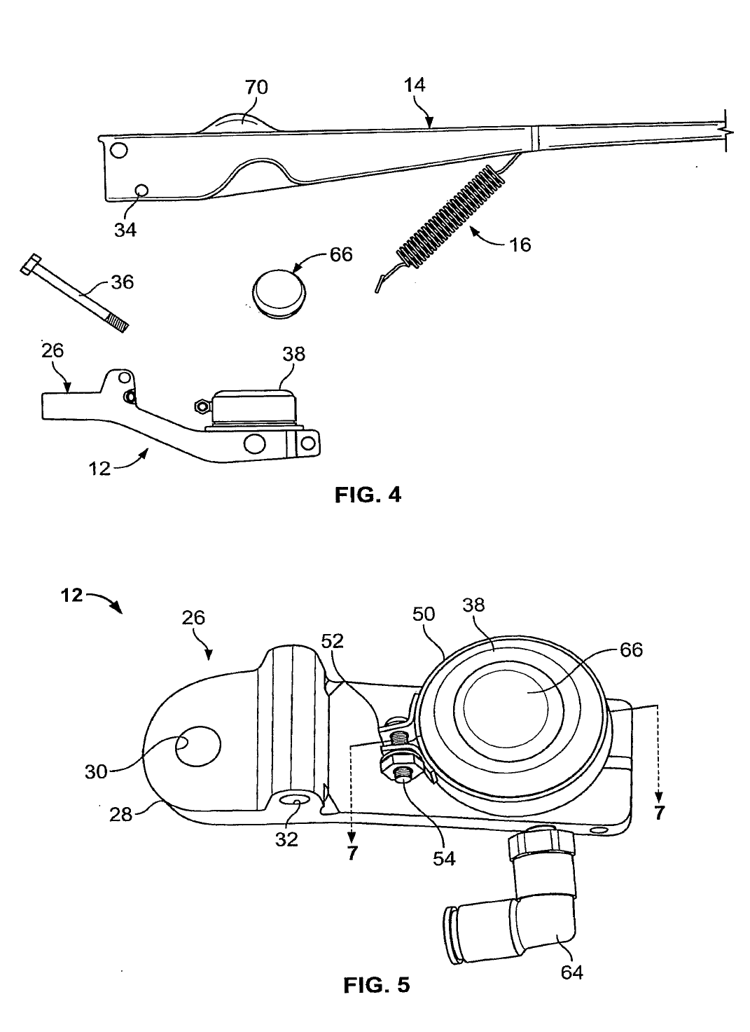

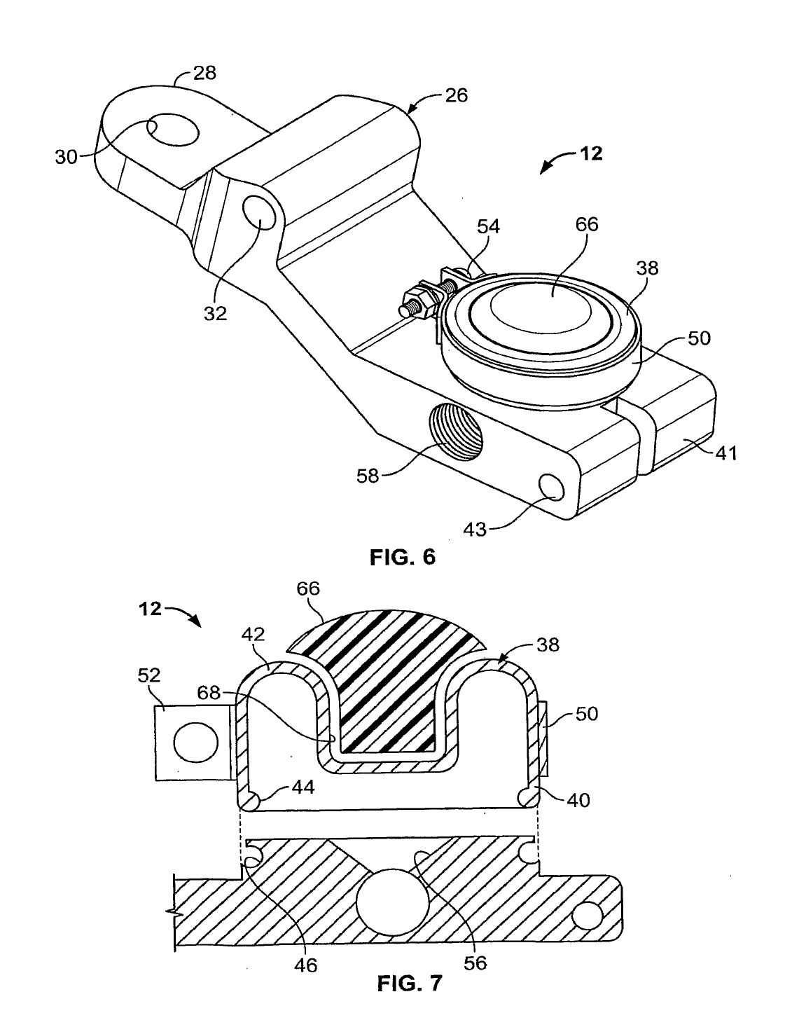

The separator assembly 12 may include a base or base portion 26. The base 26 may have a first end 28 for mounting to the output shaft 20 of the motor vehicle wiper system. The first end may define an aperture 30 (see FIGS. 5 and 6, for example) for receiving an output shaft of the conventional wiper system. In this manner, the wiper assembly 10 may be readily retrofit to existing vehicles. The base 26 may be secured to the output shaft 20 in any manner well known in the art. For example, while not particularly illustrated, the base 26 may define a threaded hole in communication with the aperture 30. As shown in FIGS. 4 and 5, for example, the base 26 may include one or more threaded holes that may receive set screws (not particularly shown) for quick and secure attachment of the base 26 to the output shaft 20. Alternatively, the base 26 may be clamped or otherwise secured to the output shaft 20. In these and other manners, the wiper assembly 10 may be mounted for rotation with the output shaft 20 about an axis defined by the output shaft 20.

The base 26 may be adapted to attachment to the wiper arm 14 such that the wiper arm 14 may be rotated about an axis relative to the base 26. The axis about which the wiper arm 14 may be rotated may be perpendicular to the axis defined by the output shaft 20. As illustrated, the base 26 may define a through bore 32 adapted to align with cooperating openings 34 in the wiper arm 14. The bore 32 and openings 34 may receive a fastener or pin 36. The fastener 36 may threadably engage a nut for securement of the wiper arm 14 to the base 26.

A second end of the base 26 may carry a bladder 38. While not visible in FIG. 2, it will be understood that the bladder 38 is in a relaxed position or deflated condition in FIG. 2. The bladder 38 is similarly in the relaxed position in FIGS. 4-7. FIG. 3 illustrates the bladder 38 in an extended position or inflated condition. In the extended position, the bladder 38 may serve to articulate the wiper arm 14 and wiper blade 18 from the lowered position of FIG. 2 to the raised position of FIG. 3.

The bladder 38 may be domed shaped and include a lower portion 40 for attachment to the base 26 and an upper portion 42 for displacing the wiper arm 14. As shown in the drawings, the bladder 38 may be secured proximate a second end 41 of the base 26. The lower portion 40 may be generally cylindrical. As shown particularly in the cross-sectional view of FIG. 7, the lower portion 40 may include a mounting structure 42. The mounting structure may define an inwardly extending circumferential flange 42. The flange 42 may be generally cylindrical and may be received within a corresponding circumferentially extending opening 44 defined by an upwardly extending wall 48 of the base 26.

A clamp 50 may surround the lower portion 40 and secure the bladder 38 to the base 26. The clamp 50 may define a pair of flanges 52. The flanges 52 may define openings for receiving a fastener 54. As shown perhaps most clearly in FIG. 5, the clamp 50 may include a ring and a pair of mounting flanges 52 welded or otherwise secured to the ring. The ring is adapted to completely or at least substantially completely surround the bladder 38. The ring may be an open ring having opposing ends. Once positioned about the bladder 38, the fastener 54 is tightened to press the free ends of the ring against one another and thereby provide a fluid tight attachment of the bladder 38 to the base. The bladder 38 may be alternatively secured to the base 26 within the scope of the present teachings.

The second end 41 of the base 26 may define a chamber 56. The chamber 56 may be in fluid communication with an inlet port 58. As shown in simplified form in FIG. 1, the inlet port 58 may be coupled to a source of pressurized air 60 through a hose 62. The source of pressurized air 60 may be an onboard compressor. The inlet port 58 may be internally threaded to receive a fitting 64 for coupling to the hose 62.

The linkage 16 may include one or more spring members. The spring members 16 may conventionally function to normally maintain the wiper 18 in contact with the vehicle windshield. An end of the linkage 16 may be secured to the base 26. For example, a free end of one of the spring members may engage an aperture 43 defined proximate the second end 41 of the base 26.

The bladder 38 may be constructed of rubber. One particular material may including fabric reinforced nitrile. Other materials providing the requisite strength and durability characteristics for the application described herein may alternatively be used. In certain applications and as shown in the drawings, it may be desirable to further include an intermediate member or domed member 66 that fits in a recess 68 defined by the upper surface of the bladder 38. The domed member 66 may be constructed of a substantially rigid plastic and may serve to limit expansion of the elastic bladder 38. The domed member 66 may also function to provide a wiper arm contact surface and thereby reduce wear of the bladder 38 as a result of engagement with the wiper arm 14. The domed member 66 may be constructed of nylon or other suitable material. Alternatively, the domed member 66 may be a discrete part or may be integrally formed with the bladder 38. Domed member 66 transfers immediate motive force. In other applications, the bladder 38 may directly contact the wiper arm 14.

In certain applications and as illustrated in the drawings, it may be desired to provide the wiper arm 14 with a recess or recessed contact surface adjacent the bladder 38. The recess may be concave in shape. The recess may serve to accommodate the bladder 38 in the relaxed position and thereby provide the wiper assembly 10 with an otherwise lower profile. The opposite side of the wiper arm 14 may include a convexly curved surface 70. This convexly curved surface 70 may be provided with trademarks or other identifiers to indicate that the wiper assembly 10 is equipped with wiper technology coming from a particular company source.

In operation, the movement of the wiper arm 14 between the raised and lowered positions can be controlled from the passenger compartment of the vehicle. For example, the movement of the wiper arm 14 may be controlled through the depression of a button 72 (see FIG. 1). The button 72 may be located on the vehicle dash board, proximate the steering column or in any other location convenient to the operator. The source of pressurized air 60 may be delivered to the bladder 38, through a solenoid air gate 57, for inflating the bladder 38 and thereby articulating the wiper arm 14 to the raised position. The solenoid air gate 57 will be understood to be conventional in construction and operation. The solenoid air gate 57 operates between open and closed positions such that when the vehicle ignition key is in the “on” position, the solenoid air gate 57 is open and when the ignition is “off”, solenoid air gate 57 is closed.

Depression of the button 72, pressurizes the bladder 38 and articulates the wiper arm 14 to the raised position. By releasing the button 72, the wiper arm 14 may quickly and forcefully return to the windshield under a conventional biasing force and thereby remove trapped debris. This action may be repeated as desired/necessary to remove ice or other debris. The air pressure may be sufficient to overcome the conventional biasing force of the linkage 16. The air pressure may be controlled to rapidly articulate the wiper arm 14 between the raised and lowered positions.

The system 10 may further be operated to maintain the wiper arm 14 in the raised position for an extended period of time. Such operation may be desired when the vehicle is parked and weather conditions are anticipated that may ice the wiper blades 18 to the windshield. The wiper arm 14 may be placed in the raised position for an extended period of time when the vehicle ignition key is in the “off” position. At this time, the solenoid air gate 57 is closed. Depression of the button 72 serves to inflate the bladder 38. Since the solenoid air gate 57 is closed, the bladder 38 cannot vent and is thereby maintained in the inflated condition. This inflated condition may be maintained overnight. In this manner, the vehicle can be left for extended periods (e.g., overnight) without the risk of the wiper blade freezing to the windshield.

With reference to FIG. 3A, another wiper system in accordance with the present teachings is illustrated and identified at reference character 100. Like reference characters are used to identify similar elements to those introduced above. The wiper system 100 differs from the wiper system 10 in that an underside of the wiper arm 14 includes a downwardly extending portion 102 received within the recess 68 of the bladder 38. The portion 102 may be integrally formed with the wiper arm 14 or secured to the wiper arm 14.

The description of the present teachings are merely exemplary in nature and, thus, variations that do not depart from the gist of the invention are intended to be within the scope of the invention. Such variations are not to be regarded as a departure from the spirit and scope of the invention.

What is claimed is:

1. A wiper system for use with a windshield, the wiper system comprising:
a wiper arm including a wiper blade movable between a use position and a raised position, the wiper blade in contact with the windshield in the use position and removed from the windshield in the raised position; and
a separator assembly including a base and an air bladder secured to the base, the base adapted to receive a source of pressurized air for selectively inflating the air bladder to toggle the wiper blade between the use position and the raised position.

2. The wiper system of claim 1, wherein the air bladder is operable in an extended position and a retracted position.

3. The wiper system of claim 1, wherein the air bladder is generally cylindrical.

4. The wiper system of claim 1, wherein the air bladder defines a recess, the recess having a first depth when the air bladder is uninflated and a second depth when the air bladder is inflated, the first depth being greater than the second depth.

5. The wiper system of claim 1, further comprising an intermediate member positioned between the air bladder and the wiper.

6. The wiper system of claim 5, wherein the intermediate member includes a lower portion received within a recess defined by the air bladder.

7. The wiper system of claim 5, wherein the intermediate member includes an upper convex surface for engaging the wiper arm.

8. The wiper system of claim 5, wherein the intermediate member is constructed of a substantially rigid material.

9. The wiper system of claim 1, wherein the an underside of the wiper arm proximate the air bladder defines a concave recess.

10. The wiper system of claim 1, wherein the base is adapted to rotate with a drive member.

11. The wiper system of claim 1, further comprising an air gate for maintaining the wiper blade in the raised position.

12. The wiper system of claim 1, further comprising a clamp including a ring substantially completely surrounding the air bladder for securing the air bladder to the base in an air-tight fashion.

13. The wiper system of claim 1, wherein the air bladder includes a circumferentially extending flange and the base defines a continuous groove for receiving the flange.

14. A wiper system for use with a windshield, the wiper system comprising:
a base member to be driven about an axis;
a wiper arm carrying a wiper blade, the wiper arm coupled to the base for movement between a normal use position in which the wiper blade is against the windshield and a raised position in which the wiper blade is displaced from the windshield;
an air bladder connected to the base in a fluid tight manner; and
a source of pressurized fluid in communication with the base for inflating the bladder to move the wiper arm from the normal use position to the raised position.

15. The wiper system of claim 14, wherein the source of pressurized fluid is pressurized air.

16. The wiper system of claim 14, further comprising an intermediate member positioned between the bladder and the wiper arm.

17. The wiper system of claim 16, wherein the intermediate member includes a substantially rigid convex portion for engaging the wiper arm.

18. The wiper system of claim 14, further comprising an air gate for maintaining the wiper arm in the raised position.

19. The wiper system of claim 14, further comprising a clamp including a ring substantially completely surrounding the air bladder

20. The wiper system of claim 19, wherein the bladder and the ring are cylindrical.
